(19) United States
(12) Patent Application Publication
(10) Pub. No.: US 2025/0034912 A1
(43) Pub. Date: Jan. 30, 2025

(54) DOOR LOCK FOR CYCLIST PROTECTION

(71) Applicant: Volvo Car Corporation, Göteborg (SE)

(72) Inventor: Sven Heyrman, Göteborg (SE)

(73) Assignee: Volvo Car Corporation, Göteborg (SE)

(21) Appl. No.: 18/361,350

(22) Filed: Jul. 28, 2023

(51) Int. Cl. E05B 77/02; E05B 81/56; G06T 7/73; G06V 20/58

(52) U.S. Cl. CPC E05B 77/02; E05B 81/56; G06T 7/73; G06V 20/58; G06T 2207/30252; G06V 2201/08

(57) ABSTRACT

In an aspect, a system is described. The system comprises a target vehicle. The target vehicle comprises a collision warning module configured to determine one or more collision zones around the target vehicle; detect one or more obstacles around the target vehicle; determine coordinates of the one or more obstacles around the target vehicle; compute a probability of the one or more obstacles lying within the one or more collision zones as true when the coordinates of the one or more obstacles are within a range of the one or more collision zones; and communicate a first command to a control module of the target vehicle to activate a locking mechanism to one or more movable elements of the target vehicle.

### FIELD OF THE INVENTION

The present disclosure relates generally to a field of transportation. More specifically, the present disclosure relates a system and method for vehicle door collision warning and prevention.

### BACKGROUND

“Along with the economic development and the improvement of the living standard of people, the automobile keeping quantity is greatly improved, and the following problems are that the traffic flow is increased, motor vehicles, non-motor vehicles, pedestrians and the like on the road are dense, the traffic environment is increasingly complex, and the parking space is short. Based on this kind of current situation, when driving a car and going out, personnel in the car easily forget to observe the peripheral condition of vehicle in advance before opening the door because of reasons such as time, safety consciousness are light and thin, often can lead to the vehicle door to collide with external moving object because of opening the door in a trade, cause the damage. In the related technology, a door opening early warning system arranged in a vehicle can monitor traffic conditions behind and beside the vehicle in real time, and sends out corresponding door opening early warning to people in the vehicle through sound or light. However, the existing door opening early warning system can only remind people in a vehicle when the door is opened, the practicability of early warning is low, the instantaneity of early warning cannot be effectively guaranteed, various emergency situations cannot be effectively handled, great potential safety hazards still exist, and improvement is urgently needed.” [Source: United States Patent application CN114162044A, titled “Automobile door opening anti-collision early warning method and device, vehicle and storage medium”, published on March 2022]

Therefore, there is a long-felt need for a system and method that effectively warns and prevents collision of vehicle doors and obstacles.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In an aspect, a system is described. The system comprises a collision warning module configured to determine one or more collision zones around the target vehicle; detect one or more obstacles around the target vehicle; determine coordinates of the one or more obstacles around the target vehicle; compute a probability of the one or more obstacles lying within the one or more collision zones as true when the coordinates of the one or more obstacles are within a range of the one or more collision zones; and communicate a first command to a control module of the target vehicle to activate a locking mechanism to one or more movable elements of the target vehicle.

In another aspect, a method is described. The method comprises: determining, by a collision warning module, one or more collision zones around a target vehicle; detecting, by the collision warning module, one or more obstacles around the target vehicle; determining, by the collision warning module, coordinates of the one or more obstacles around the target vehicle; computing, by the collision warning module, a probability of the one or more obstacles lying within the one or more collision zones as true when the coordinates of the one or more obstacles are within a range of the one or more collision zones; and communicating, by the collision warning module, a first command to a control module of the target vehicle to activate a locking mechanism to one or more movable elements of the target vehicle.

In yet another aspect, a non-transitory storage medium is described. The non-transitory storage medium storing a sequence of instructions which when executed by a processor causes: determining one or more collision zones around a target vehicle; detecting one or more obstacles around the target vehicle; determining coordinates of the one or more obstacles around the target vehicle; computing a probability of the one or more obstacles lying within the one or more collision zones as true when the coordinates of the one or more obstacles are within a range of the one or more collision zones; and communicate a first command to a control module of the target vehicle to activate a locking mechanism to one or more movable elements of the target vehicle.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE FIGURES

Aspects of the present disclosure will now be described in more detail, with reference to the appended drawings showing exemplary embodiments, in which:

FIG. 1 illustrates a system, according to one or more embodiments.

FIG. 2 illustrates components of a vehicle, according to one or more embodiments.

FIGS. 3A and 3B illustrate an obstacle approaching a target vehicle, according to one or more embodiments.

FIG. 4 illustrates a system, according to one or more embodiments.

FIG. 5 illustrates a method, according to one or more embodiments.

FIG. 6 illustrates a non-transitory storage medium execution by a processor, according to one or more embodiments.

FIG. 7 illustrates a flowchart illustrating determination of obstacles around the target vehicle and prevention of collision, according to one or more embodiments.

FIG. 8 illustrates a vehicle to vehicle data transfer, according to one or more embodiments.

FIG. 9 illustrates a warning provided by the target vehicle upon predicting the collision of obstacle with the target vehicle, according to one or more embodiments.

FIGS. 10A, 10B, and 10C illustrate sample messages received by a target vehicle, according to one or more embodiments.

FIG. 11A shows a block diagram of a cyber security module in view of the system and server.

FIG. 11B shows an embodiment of the cyber security module.

FIG. 11C shows another embodiment of the cyber security module.

FIG. 12A shows a structure of a neural network/machine learning model with a feedback loop.

FIG. 12B shows a structure of the neural network/machine learning model with reinforcement learning.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or made clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include”, “have”, and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left”, “right”, “front,” “back”, “top”, “bottom”, “over”, “under”, and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having.” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple”, “coupled”, “couples”, “coupling”, and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably”, “removable”, and the like, near the word “coupled”, and the like does not mean that the coupling, etc., in question is or is not removable.

As used herein, the term “or” means an inclusive “or” rather than an exclusive “or.” That is, unless specified otherwise, or clear from context, “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Digital electronic circuitry, or in computer software, firmware, or hardware, including the structures disclosed in this specification and their structural equivalents, or in combinations of one or more of them, may realize the implementations and all of the functional operations described in this specification. Implementations may be as one or more computer program products, i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data, e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc., may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship to each other.

Embodiments may comprise or utilize a special purpose or general purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs. DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCS, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

The following terms and phrases, unless otherwise indicated, shall have the following meanings.

As used herein, the term “cryptographic protocol” is also known as security protocol or encryption protocol. It is an abstract or concrete protocol that performs a security-related function and applies cryptographic methods often as sequences of cryptographic primitives. A protocol describes usage of the algorithms. A sufficiently detailed protocol includes details about data structures and representations, to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

Secure application-level data transport widely uses cryptographic protocols. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation.

Networking switches use cryptographic protocols, like Secure Socket Layer (SSL) and Transport Layer Security (TLS), the successor to SSL, to secure data communications over a wireless network.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “IoT” stands for Internet of Things which describes the network of physical objects “things” or objects embedded with sensors, software, and other technologies for the purpose of connecting and exchanging data with other devices and systems over the internet.

As used herein “Machine learning” refers to algorithms that give a computer the ability to learn without explicit programming, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning. Naive Bayes, nearest neighbor, decision tree, decision tree learning, and hidden Markov, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the AI/ML model improving the model's accuracy and performance over time.

Statistical modeling relies on finding relationships between variables (e.g., mathematical equations) to predict an outcome.

As used herein, the term “Data mining” is a process used to turn raw data into useful information.

As used herein, the term “Data acquisition” is the process of sampling signals that measure real world physical conditions and converting the resulting samples into digital numeric values that a computer manipulates. Data acquisition systems typically convert analog waveforms into digital values for processing. The components of data acquisition systems include sensors to convert physical parameters to electrical signals, signal conditioning circuitry to convert sensor signals into a form that can be converted to digital values, and analog-to-digital converters to convert conditioned sensor signals to digital values. Stand-alone data acquisition systems are often called data loggers.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “Sensor” is a device that measures physical input from its environment and converts it into data that is interpretable by either a human or a machine. Most sensors are electronic, which presents electronic data, but some are simpler, such as a glass thermometer, which presents visual data.

In an embodiment, sensors may be removably or fixedly installed within the vehicle and may be disposed in various arrangements to provide information to the autonomous operation features. Among the sensors may be included one or more of a GPS unit, a radar unit, a LIDAR unit, an ultrasonic sensor, an infrared sensor, an inductance sensor, a camera, an accelerometer, a tachometer, or a speedometer. Some of the sensors (e.g., radar, LIDAR, or camera units) may actively or passively scan the vehicle environment for obstacles (e.g., other vehicles, buildings, pedestrians, etc.), roadways, lane markings, signs, or signals. Other sensors (e.g., GPS, accelerometer, or tachometer units) may provide data for determining the location or movement of the vehicle (e.g., via GPS coordinates, dead reckoning, wireless signal triangulation, etc.).

The term “vehicle” as used herein refers to a thing used for transporting people or goods. Automobiles, cars, trucks, buses etc. are examples of vehicles.

The term “electronic control unit” (ECU), also known as an “electronic control module” (ECM), is usually a module that controls one or more subsystems. Herein, an ECU may be installed in a car or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles' computer or vehicles' central computer and may include separate computers. In an example, the electronic control unit can be an embedded system in automotive electronics. In another example, the electronic control unit is wirelessly coupled with the automotive electronics.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer readable medium” is expressly defined to include any type of computer readable storage device and/or storage disk and to exclude propagating signals.

The term “Vehicle Data bus” as used herein represents the interface to the vehicle data bus (e.g., CAN, LIN, Ethernet/IP, FlexRay, and MOST) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in an RS-232 serial transmission. A software handshake sends codes such as “synchronize” (SYN) and “acknowledge” (ACK) in a TCP/IP transmission.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “control module” as used herein refers to those parts of a digital computer that regulate the carrying out of instructions in proper sequence, the interpretation of each instruction, and the application of the proper signals to the arithmetic unit and other parts in accordance with this interpretation. The control unit or control module may be referring to an electronic control unit or a sub-system of the ECU and may be referring to a functional unit in an electronic control unit or a sub-system that controls one or more units of the vehicle's equipment.

The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging, etc.

The term “autonomous mode” as used herein refers to an operating mode which is independent and unsupervised.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “autonomous vehicle” also referred to as self-driving vehicle, driverless vehicle, robotic vehicle as used herein refers to a vehicle incorporating vehicular automation, that is, a ground vehicle that can sense its environment and move safely with little or no human input. Self-driving vehicles combine a variety of sensors to perceive their surroundings, such as thermographic cameras, Radio Detection and Ranging (radar), Light Detection and Ranging (lidar), Sound Navigation and Ranging (sonar), Global Positioning System (GPS), odometry and inertial measurement unit. Control systems, designed for the purpose, interpret sensor information to identify appropriate navigation paths, as well as obstacles and relevant signage.

The term “communication system” or “communication module” as used herein refers to a system which enables the information exchange between two points. The process of transmission and reception of information is called communication. The major elements of communication include but are not limited to a transmitter of information, channel or medium of communication and a receiver of information.

The term “connection” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networking. A channel is used for the information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles.

The term “communication” as used herein refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units. The term “in communication with” may refer to any coupling, connection, or interaction using electrical signals to exchange information or data, using any system, hardware, software, protocol, or format, regardless of whether the exchange occurs wirelessly or over a wired connection. The term communication includes systems that combine other more specific types of communication, such as V2I (Vehicle-to-Infrastructure), V2I (Vehicle-to-Infrastructure), V2N (Vehicle-to-Network), V2V (Vehicle-to-Vehicle), V2P (Vehicle-to-Pedestrian), V2D (Vehicle-to-Device) and V2G (Vehicle-to-Grid) and Vehicle-to-Everything (V2X) communication.

Further, the communication apparatus is configured on a computer with the communication function and is connected for bidirectional communication with the on-vehicle emergency report apparatus by a communication line through a radio station and a communication network such as a public telephone network or by satellite communication through a communication satellite. The communication apparatus is adapted to communicate, through the communication network, with communication terminals.

The term “vehicle to vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications or traffic condition detection) that can use the messages from surrounding vehicles to determine potential crash threats as they develop.

The term “protocol” as used herein refers to a procedure required to initiate and maintain communication; a formal set of conventions governing the format and relative timing of message exchange between two communications terminals; a set of conventions that govern the interaction of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications within a computer system or network; a formal set of conventions governing the format and relative timing of message exchange in a computer system; a set of semantic and syntactic rules that determine the behavior of functional units in achieving meaningful communication; a set of semantic and syntactic rules for exchanging information.

The term “V2X communication” as used herein refers to transmission of information from a vehicle to any entity that may affect the vehicle, and vice versa. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

The term “communication protocol” as used herein refers to standardized communication between any two systems. An example communication protocol is a DSRC protocol. The DSRC protocol uses a specific frequency band (e.g., 5.9 GHZ) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the IEEE and SAE International.

The term “bidirectional communication” as used herein refers to an exchange of data between two components. In an example, the first component can be a vehicle and the second component can be an infrastructure that is enabled by a system of hardware, software, and firmware.

The term “alert” or “alert signal” refers to a communication to attract attention. An alert may include visual, tactile, audible alert, and a combination of these alerts to warn drivers or occupants. These alerts allow receivers, such as drivers or occupants, the ability to react and respond quickly.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

As used herein, the term “electric drive unit” refers to a unit that can control the operation of various devices of the target vehicle. The electric drive unit is responsible for enabling the mobility of the vehicle.

As used herein, the term “obstacle” refers to an object, a vehicle, a tree, a wall, or an animal approaching from behind towards a vehicle, or to prevent the vehicle from opening doors or parking by causing difficulties (e.g., collision).

As used herein, the term “collision zone” refers to a zone or a region or a space up to which the movable elements of the vehicle may occupy while operating i.e., opening or closing of the movable elements. The moveable elements may comprise doors of the vehicles, vehicle trunk doors, vehicle boot doors, etc. The movable elements may be automatically operated or manually operated.

As used herein, the term “target vehicle” refers to a vehicle for which the collision is monitored and prevented. The target vehicle may be an autonomous vehicle, self-driving vehicle, or manual driven vehicle. The target vehicle may be an electric vehicle. The target vehicle may also be a hybrid vehicle. The target vehicle may be a car, a truck, a bus, a commercial vehicle, a load vehicle, etc.

As used herein, the term “third party service” refers to any unaffiliated person, company, or entity that performs services for a company. Third-party service providers may be paid for their services, but do not have a stake, share, or equity in the company. Third-party service providers may also be free of cost for their services. Third-party services may also be web-based technologies that are not exclusively operated or controlled by a government entity or that involve significant participation of a non-government entity.

As used herein, the term “coordinates” refers to any set of numbers or points used in specifying the location of a point on a line, on a surface, or in space. latitude and longitude coordinates. The coordinates refers to a set of values that show an exact position. On graphs it is usually a pair of numbers: the first number shows the distance along, and the second number shows the distance up or down. Example: the point (12,5) is 12 units along, and 5 units up.

As used herein, the term “range” refers to a boundary or contour of the collision zone. The term range may also refer to a space or region occupied by the collision zone.

As used herein, the term “probability” refers to possibility of the outcome of any random event. Probability can be defined as the ratio of the number of favorable outcomes to the total number of outcomes of an event. Probability further refers to the chances of occurrences of an event. The event herein refers to an obstacle approaching from behind the vehicle. The event herein may also refer to an obstacle approaching the vehicle from any direction. The event herein refers to a collision between the vehicle and the obstacle.

As used herein, the term “true” refers to an unknown actual probability that an event will occur in a given situation.

As used herein, the term “false” refers to an unknown actual probability that an event will not occur in a given situation.

As used herein, the term “real-time location” refers to a location of someone or something (e.g., vehicle, obstacle, etc.) in real-time. The real-time location may be determined continually or when interrogated. The real-time location may be determined via coordinates.

As used herein, the term “video analytics” refers to a practical solution for reviewing hours of video (e.g., surveillance video) to identify incidents that are pertinent to what you are looking for. Video analytics is adapted to automatically generate descriptions of what is actually happening in the video (so-called metadata), which can be used to list persons, cars and other objects detected in the video stream (e.g., obstacle approaching the vehicle, parking of the vehicle against the obstacle, collision between the vehicle and the obstacle, etc.), as well as their appearance and movements.

As used herein, the term “locking mechanism” refers to a mechanical system which provides assistance to the coupling and uncoupling of two connectors and the fixation of the two parts in operating position. The locking mechanism may also be an electromechanical system. The locking mechanism may also refer to a power-door-lock actuator positioned below the latch. In one embodiment, a rod connects the actuator to the latch, and another rod connects the latch to the knob that sticks up out of the top of the door. When the actuator moves the latch up, it connects the outside door handle to the opening mechanism. When the latch is down, the outside door handle is disconnected from the mechanism so that it cannot be opened. To unlock the door, the control module supplies power to the door-lock actuator for a timed interval.

The term “movable elements” as used herein refers to elements or components of the vehicle that are moveable. The movable elements may be fixed (via a hinge, mechanical coupling, hydraulics, a vacuum, and the like) to the vehicle. The movable elements may operate either automatically or manually. The movable elements may be connected via a central lock which can actuate all locks. In one embodiment, the movable elements may also comprise the individual locks that can be actuated or activated independently and individually.

The term “type of the target vehicle” as used herein refers to a group or set of vehicles, e.g., commercial vehicles, load vehicles, passenger vehicles, heavy vehicles, four wheeler, cight wheeler, etc. The type of the target vehicle provides information regarding the movable elements associated with the vehicle. The type of the target vehicle provides information regarding the number of movable elements and their positions associated with the target vehicle. The type of the target vehicle provides information regarding their operation in the target vehicle.

The term “model of the target vehicle” as used herein refers to a specific kind among a group or set of vehicles, e.g., commercial vehicles, load vehicles, passenger vehicles, heavy vehicles, four wheelers, eight wheelers, etc. The type of the target vehicle provides information regarding the movable elements associated with the vehicle. The type of the target vehicle provides information regarding the number of movable elements and their positions associated with the target vehicle. The type of the target vehicle provides information regarding their operation in the target vehicle.

The term “specification of the target vehicle” as used herein refers to a list of target vehicle details. The specification may also comprise features of the target vehicle. The specification may also comprise dimensions of the target vehicle. The specification may also comprise advanced technologies embedded in the target vehicle.

The term “operating information” as used herein refers to information regarding an operating mode, an operating type, an operating angle, a space occupied, and an operating level information of the one or more movable elements. The operating information provides end-to-end information about the movable elements when operating. The operating mode provides details regarding automated operating mode and a manually operating mode. The operating angle provides details regarding angle between the vehicle body and the movable end of the movable elements. The space occupied refers to the collision zones in part. The space occupied refers to the region covered by the movable elements. The operating level information may comprise a level 1, a level 2, and a level 3.

The term “ADAS sensors” as used herein refers to a group of automotive sensors used in advanced driver assistance systems. These sensors help keep vehicles and/or drivers safe by providing information about the car's surroundings. There are many different types of ADAS sensors, including cameras, radar, lidar (light detection and ranging), sonar/ultrasonic, and more.

The term “scene” as used herein refers to a place where an action or an event occurs. The scene may be around the target vehicle encompassing one or more obstacles around the target vehicle.

The term “Computer vision” as used herein refers to a field of artificial intelligence (AI) that enables computers and systems to derive meaningful information from digital images, videos and other visual inputs and takes actions or makes recommendations based on that information. If AI enables computers to think, computer vision enables them to see, observe and understand. Computer vision works much the same as human vision, except humans have a head start. Computer vision trains the computer or machines to perform these functions in much less time with cameras, data and algorithms rather than retinas, optic nerves, and a visual cortex. As the system is trained to inspect products or watch a production asset, the system can analyze thousands of products or processes a minute, noticing imperceptible defects or issues, it can quickly surpass human capabilities.

The term “ruler” as used herein refers to a sliding marker to measure lengths and show precise measurements on its digital display. The ruler can display different units and scales, divide into increments, and save data to a mobile app. Add-ons include a pen holder, a magnifier, and a caliper. The ruler is used to drag the height and width lines to display the dimensions of the object that is measured.

The term “boundary” as used herein refers to a real or an imagined line that marks the limits of something and divides it from other places or things. The boundary is something that indicates or fixes a limit or extent. The boundary refers to the line or thing marking a limit, bound, border.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices, and data from cyber-attacks and threats. It aims to reduce the risk of cyber-attacks and protects against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers-say, ‘A’ is ‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DOS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs (e.g., collision, obstacle approaching the vehicle, etc.). An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

The term “autonomous vehicle” also referred to as self-driving vehicle, driverless vehicle, robotic vehicle as used herein refers to a vehicle incorporating vehicular automation, that is, a ground vehicle that can sense its environment and move safely with little or no human input. Self-driving vehicles combine a variety of sensors to perceive their surroundings, such as thermographic cameras, Radio Detection and Ranging (radar), Light Detection and Ranging (lidar), Sound Navigation and Ranging (sonar), Global Positioning System (GPS), odometry and inertial measurement unit. Control systems, designed for the purpose, interpret sensor information to identify appropriate navigation paths, as well as obstacles and relevant signage.

As used herein the term “connection” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networking. A channel is used for information transfer of, for example a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles.

As used herein, the term “communication” refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units.

The term “in communication with” may refer to any coupling, connection, or interaction using electrical signals to exchange information or data, using any system, hardware, software, protocol, or format, regardless of whether the exchange occurs wirelessly or over a wired connection. The term communication includes systems that combine other more-specific types of communication, such as V2I (Vehicle-to-Infrastructure), V2I (Vehicle-to-Infrastructure), V2N (Vehicle-to-Network), V2V (Vehicle-to-Vehicle), V2P (Vehicle-to-Pedestrian), V2D (Vehicle-to-Device) and V2G (Vehicle-to-Grid) and Vehicle-to-Everything (V2X) communication. V2X communication is the transmission of information from a vehicle to any entity that may affect the vehicle, and vice versa. The main motivations for developing V2X are occupant safety, road safety, traffic efficiency and energy efficiency. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

As used herein, the term “vehicle to vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “protocol” as used herein refers to a procedure required to initiate and maintain communication; a formal set of conventions governing the format and relative timing of message exchange between two communications terminals; a set of conventions that govern the interaction of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications within a computer system or network; a formal set of conventions governing the format and relative timing of message exchange in a computer system; a set of semantic and syntactic rules that determine the behavior of functional units in achieving meaningful communication; a set of semantic and syntactic rules for exchanging information.

The term “communication protocol” as used herein refers to standardized communication between any two systems. An example of a communication protocol is Health Level Seven (HL7). HL7 is a set of international standards used to provide guidance with transferring and sharing data between various healthcare providers. HL7 is a comprehensive framework for the exchange, integration, sharing, and retrieval of health information.

The term “bidirectional communication” as used herein refers to an exchange of data between two components. In an example, the first component can be a vehicle and the second component can be an infrastructure that is enabled by a system of hardware, software, and firmware. This communication is typically wireless.

The term “nearby vehicle” as used herein refers to surrounding vehicles of the user's vehicle and is within reach or beyond reach of at least a communication range of the user's vehicle, wherein the communication range is defined as the maximum distance where communication can exist between two antennas, one of which is user's vehicle antenna in a wireless network. In an embodiment, “nearby vehicle” is written as a surrounding vehicle, trailing vehicle, or leading vehicle. The nearby vehicle may also include vehicles from nearby lanes, opposite lanes, or adjacent lanes.

The term “auto lock” as used herein refers to an advanced system, specifically designed to prevent possible collision. The vehicle may comprise an auto locking unit receiving instructions from an electric drive unit or from a control module via a collision warning module. The auto locking comprises a central locking unit for all movable elements. In an embodiment, the auto locking comprises an individual locking unit having an individual lock for each movable element or combination of movable elements.

As used herein, the term “probability” denotes the possibility of the outcome of any random event (e.g., collision, obstacle approaching towards the vehicle, obstacle lying within the collision zone, etc.). The meaning of this term is to check the extent to which any event is likely to happen. The term probability can also be defined as the ratio of the number of favorable outcomes to the total number of outcomes of an event.

As used herein, the term “external infrastructure” refers to any external object, building, bridge, frame, construction, tree, etc. that is residing outside of the vehicle and the obstacle. The external infrastructure may be in the field of view of the vehicle and/or the obstacles.

As used herein, the term “command” refers to an order to be followed. The order may be given in an official way.

As used herein, the term “natural language processing (NLP)” refers to a machine learning technology that gives computers the ability to interpret, manipulate, and comprehend human language. The natural language processing is adapted to understand the context of the written, pictorial representation, text, speech, or other form of contents. NLP combines computational linguistics, a rule-based modeling of human language, with statistical, machine learning, and deep learning models. NLP drives computer programs that translate text from one language to another, respond to spoken commands, and summarize large volumes of text rapidly-even in real time.

As used herein, the term “artificial intelligence (AI)” refers to intelligence of perceiving, synthesizing, and inferring information demonstrated by machines, as opposed to intelligence displayed by humans or by other animals. Artificial intelligence combines reliable datasets and computer technology to enable problem solving by analyzing, interpreting, understanding the pattern, learning, and making decisions accordingly. Artificial intelligence may be used to train the system further from the previous datasets and update dynamically in decision making and providing outputs in subsequent iterations of learning.

As used herein, the term “component” broadly construes hardware, firmware, and/or a combination of hardware, firmware, and software.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++, or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics, and/or the like can practice the herein described computer-implemented methods. Distributed computing environments, in which remote processing devices linked through a communications network perform tasks, can also practice the illustrated aspects. However, stand-alone computers can practice one or more, if not all, aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store”, “storage”, “data store”, data storage”, “database”, and any other information storage component relevant to operation and functionality of a component refer to “memory components”, entities embodied in a “memory”, or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes”, “has”, “possesses”, and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

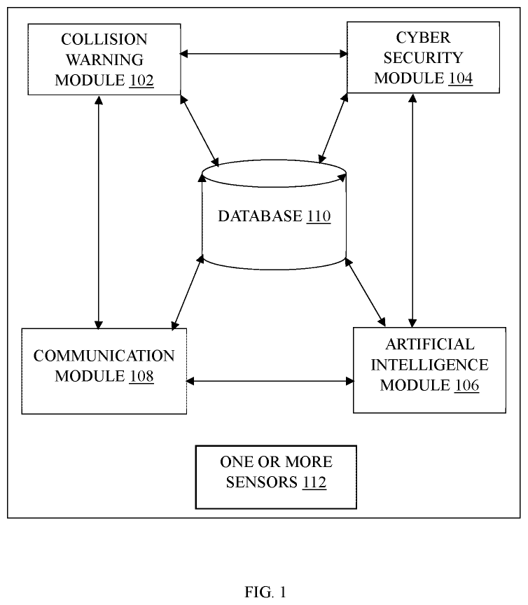

In an aspect, a system is described. FIG. 1 illustrates a system according to one or more embodiments. In one embodiment, the system is part of the target vehicle. In another embodiment, the system is part of one or more external infrastructures. In another embodiment, the system is part of one or more nearby vehicles.

The system comprises a collision warning module 102, a cybersecurity module 104, an artificial intelligence module 106, and a communication module 108. The communication module 108 is configured to communicate with the vehicle and other external systems, databases, and components. The communication module 108 comprises a wireless communication module. The collision warning module 102 is configured to determine one or more collision zones around a target vehicle; detect one or more obstacles around the target vehicle; determine coordinates of the one or more obstacles around the target vehicle; compute a probability of the one or more obstacles lying within the one or more collision zones as true when the coordinates of the one or more obstacles are within a range of the one or more collision zones; and communicate a first command to a control module 202 of the target vehicle to activate a locking mechanism to one or more movable elements of the target vehicle. The one or more movable elements comprises one or more doors. The one or more obstacles comprises one or more objects, one or more animals, one or more nearby vehicles, one or more walls, one or more trees, one or more moving objects, and one or more moving animals.

In one embodiment, the collision warning module 102, determining the one or more collision zones around the target vehicle, comprises the following technical steps. The collision warning module 102 obtains a type and a model of the target vehicle. The collision warning module 102 then retrieves a specification of the target vehicle based on the type and the model of the target vehicle from a third party database. The collision warning module 102 retrieves at least one of a position and operating information of the one or more movable elements of the target vehicle from one of the third party database and the specification of the target vehicle. The collision warning module 102 determines the one or more collision zones based on one of the position and the operating information of the one or more movable elements of the target vehicle.

In an embodiment, the operating information comprises an operating mode, an operating type, an operating angle, a space occupied, and an operating level information. The operating mode comprises an automated operating mode and a manual operating mode. The operating angle comprises at least one of 45 degrees, 60 degrees, and 90 degrees. In one embodiment, the operating angle may comprise a specific customized angle with respect to the target vehicle. The operating level information comprises one of a level 1, a level 2, and a level 3. The operating type comprises a regular type, a sliding type, a suicide type, a canopy type, a butterfly type, a raptor type, a swan type, a scissor type, a front hinged type, a dihedral synchro-helix actuation type, and a gull wing type. The sliding type operates along a length of the target vehicle. The regular type operates outwards and opens away from a body of the target vehicle.

The collision warning module 102 determines at least one of the position and operating information of the one or more movable elements of the target vehicle from one or more images and one or more videos of the scene encompassing the target vehicle. In one embodiment, the collision warning module 102 uses the artificial intelligence module 106 to determine at least one of the position and operating information of the one or more movable elements of the target vehicle. The artificial intelligence module 106 comprises a computer vision module that operates in conjunction with one or more camera sensors. In another embodiment, the one or more camera sensors captures a scene around the target vehicle in the form of at least one of one or more images and one or more videos. The computer vision module detects the one or more obstacles and the one or more collision zones around the target vehicle from the one or more images and the one or more videos. The computer vision module detects whether the one or more obstacles from the one or more images and the one or more videos lies within the one or more collision zones. The computer vision module communicates the first command to the collision warning module when the one or more obstacles from the one or more images and the one or more videos lies within the one or more collision zones. The first command instructs the collision warning module to activate the locking mechanism.

The computer vision module analyses at least one of the one or more images and the one or more videos and detects whether the one or more obstacles is moving. In one embodiment, the computer vision module detects that the one or more obstacles is moving when the coordinates of the one or more obstacles in a first image is different when compared to a second image of the one or more images. In another embodiment, the computer vision module detects that the one or more obstacles is moving when the coordinates of the one or more obstacles in a first video is different when compared to a second video of the one or more videos. The computer vision module detects a speed of the one or more obstacles based on the coordinates of the one or more obstacles in the first video and the second video. The computer vision module calculates a time taken by the one or more obstacles to reach the one or more collision zones. The computer vision module communicates the first command to the collision warning module within a predefined time from the time calculated to activate the locking mechanism.

In one embodiment, the collision warning module 102 utilizes computer vision module to perform video analytics in order to determine at least one of the position and operating information of the one or more movable elements of the target vehicle from the images and videos. In one embodiment, the computer vision module is capable of analyzing and interpreting the sequence of actions or events from the series of images and the series of videos to determine the position and operating information of the one or more movable elements of the target vehicle. In another embodiment, the collision warning module 102 utilizes computer vision module to determine that the one or more collision zones are one of contiguous and non-contiguous and located in proximity to the one or more movable elements. The computer vision module projects an imaginary illumination against the contours or boundaries of the one or more collision zones and marks the boundaries of the one or more collision zones individually. The computer vision module then determines whether the one or more collision zones are contiguous or non-contiguous based on the boundaries marked.

In one embodiment, the computer vision module communicates the instructions to the control module via the collision warning module 102 to trigger a central lock when the one or more collision zones are contiguous. In one embodiment, the computer vision module communicates the instructions to the control module via the collision warning module 102 to trigger a respective lock of the movable element when the one or more collision zones are non-contiguous. The control module then communicates instructions to the auto lock unit to lock the respective movable elements of the target vehicle upon computing the probability of the collision. In another embodiment, the collision warning module 102 communicates instructions to deactivate the lock and allow the opening of the respective movable element (e.g., door) when the obstacle is dynamic (i.e., moving and passing away). In another embodiment, the collision warning module 102 communicates instructions to communicate a first warning to the occupants (e.g., driver, passengers, etc.) of the target vehicle about the probability of the collision and to remain the lock of the respective movable elements (e.g., door) to be locked when the obstacle is static (i.e., stationary and within the collision zone). In another embodiment, the collision warning module 102 communicates instructions to communicate a second warning to the target vehicle about the probability of the collision to maneuver the target vehicle to a predefined distance from the current location in a predefined direction to operate the movable elements without collision, when the obstacle is static (i.e., stationary and within the collision zone). In an embodiment, the warning may be in the form of a command, a message, an audio, a video, a pictorial representation, etc. The control module may display the warning in the display of the dashboard via the infotainment unit upon receiving instructions from the collision warning module 102. In another embodiment, the collision warning module 102 communicates instructions to the nearby vehicles about the probability of the collision and to maintain safe distance to the target vehicle and to the obstacles to avoid collision. In another embodiment, the collision warning module 102 communicates instructions to the control module of the target vehicle about the probability of the collision and provides an alert via lamp blinking, beeps, an audio alert, etc., to the obstacles (e.g., animals, moving vehicles, cyclist, etc.).

In one embodiment, the artificial intelligence module 106 comprises a natural language processing module. The natural language processing module is adapted to understand the context of the written, pictorial representation, text, speech, or other form of contents in the specification of the target vehicle and determines the position and operating information of the movable elements. In one embodiment, the natural language processing is adapted to understand the context of the written, pictorial representation, text, speech, or other form of contents from a third party database and determines the position and operating information of the movable elements. In one embodiment, the natural language processing is adapted to understand the context of the written, pictorial representation, text, speech, or other form of contents in a parking space or scene around the target vehicle and determines position and movements of the obstacles. NLP combines computational linguistics, a rule-based modeling of human language, with statistical, machine learning, and deep learning models. NLP drives computer programs that translate text from one language to another, respond to spoken commands, and summarize large volumes of text rapidly-even in real time. The natural language processing module communicates instructions to the control module via the collision warning module to prevent collision against a vehicle door opening.

In one embodiment, the collision warning module 102 comprises one or more sensors 112. The one or more sensors 112 may be part of the target vehicle. In another embodiment, the one or more sensors 112 are part of one or more external infrastructures. In another embodiment, the one or more external infrastructures is around a parking area. In another embodiment, the one or more sensors 112 are part of one or more nearby vehicles. The one or more sensors 112 comprises one or more Light Detection and Ranging (LIDAR) sensors, one or more ultrasonic sensors, one or more camera sensors, one or more infrared sensors, one or more radio detection and ranging (RADAR) sensors and one or more advanced driver assistance system (ADAS) sensors.

For example, the radio detection and ranging (RADAR) sensors detect the presence and distance of objects using radio frequencies. The distance of an obstacle is calculated from the time taken for the radio waves to travel to the object and, after reflection from it, return back. Light detection and ranging (lidar) systems work much the same way; the only difference is they use laser light instead of radio waves. The LIDAR sensor sends laser pulses and calculates the distance of an object from it using the time of flight. The LIDAR oscillates to find the obstacle within its range and displays the same on a graphic liquid crystal display (GLCD). Similarly, for example, the infrared sensors (IR sensors) emit infrared light, and once this light hits an object, it is reflected back to the sensor. The infrared LED emits infrared signals at certain frequency and when an obstacle appears on the line of infrared light, the IR light is reflected back by the obstacle which is sensed by the receiver. The IR sensor detects the distance of the obstacle based on the time taken for the radio waves to travel to the object. The ADAS sensors may employ any of the above sensors and detect the obstacle and distance between the obstacle and the vehicle and further detect whether the obstacle is in the direction of approaching towards the vehicle. The sensors communicate the information to the collision warning module 102 to compute the probability of collision.

In one embodiment, the collision warning module 102 is configured to compute the probability of the one or more obstacles lying within the one or more collision zones as false when the coordinates of the one or more obstacles are outside the range of the one or more collision zones. The collision warning module 102 then communicates a second command to release the locking mechanism to the one or more movable elements when the probability of the one or more obstacles lying within the one or more collision zones is computed as false.

In one embodiment, the collision warning module 102 determining the coordinates of the one or more obstacles around the target vehicle comprises the following technical steps. The collision warning module 102 captures one or more images around the target vehicle encompassing the one or more obstacles and the one or more collision zones. The collision warning module 102 then overlays a ruler onto the one or more images and marking points of the one or more obstacles. The collision warning module 102 then determines the coordinates of the one or more obstacles.

In one embodiment, the collision warning module 102 marks one or more boundaries of the one or more collision zones and determines coordinates of the one or more boundaries of the one or more collision zones. The collision warning module 102 analyses the coordinates of the one or more boundaries of the one or more collision zones and determines whether the coordinates of the one or more obstacles are within the one or more boundaries of the one or more collision zones.

The collision warning module 102 computes the probability of the one or more obstacles lying within the one or more collision zones as true when the coordinates of the one or more obstacles are within the coordinates of the one or more boundaries of the one or more collision zones. In one embodiment, the collision warning module 102 computes the probability of the one or more obstacles lying within the one or more collision zones as false when the coordinates of the one or more obstacles is outside the coordinates of the one or more boundaries of the one or more collision zones.

The database 110 records the information and/or datasets regarding the obstacles, collision zones, coordinates of the obstacles, coordinates of the collision zones, vehicle specification, etc. The artificial intelligence module 106 is pretrained initially. The datasets may then be used to subsequently train the artificial intelligence module 106. The first datasets comprise predefined coordinates of the collision zones for the target vehicles, predefined coordinates of the obstacles, predefined specifications of the target vehicles, predefined operating information of the target vehicles, predefined position information of the movable elements associated with the target vehicles.

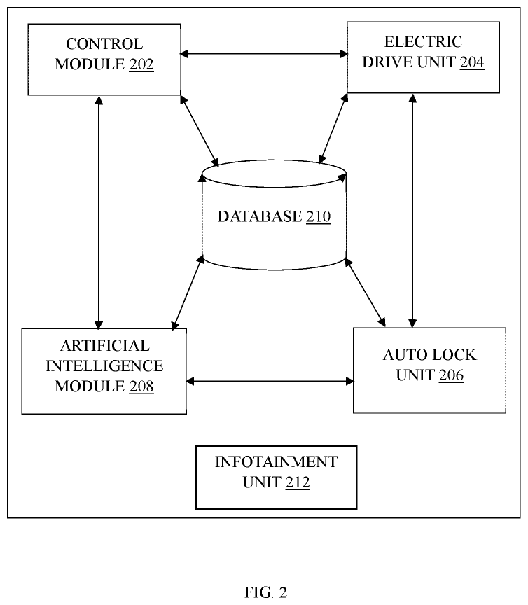

FIG. 2 illustrates components of a target vehicle, according to one or more embodiments. The target vehicle comprises a control module 202, an electric drive unit 204, an auto lock unit 206, and an artificial intelligence module 208. The target vehicle further comprises the database 210. The control module 202 receives the command from the collision warning module. The control module coordinates with all other components for execution of the activities within the target vehicle. The control module 202 communicates instructions to other components of the target vehicle. The control module 202 may be referring to an electronic control unit or a sub-system of the ECU and may be referring to a functional unit in an electronic control unit or a sub-system that controls one or more units of the vehicle's equipment.

The electric drive unit 204 refers to a unit that can control the operation of various devices of the target vehicle. The electric drive unit 204 is responsible for enabling the mobility of the target vehicle. The auto lock unit 206 is configured to activate lock and deactivate lock for the one or movable elements (e.g., doors). The auto lock unit 206 may be configured to activate or deactivate the central lock based on the instruction received from the collision warning module through the control module 202. In one embodiment, the auto lock unit 206 may be configured to activate or deactivate the individual locks for the respective movable element based on the instructions received from the collision warning module through the control module 202. The auto lock unit 206 may activate the individual locks and/or central lock for a predefined period of time when the obstacle is moving. The auto lock unit 206 then may deactivate the individual locks and/or central lock for a predefined period of time when the obstacle is moving and has crossed the collision zone.

The artificial intelligence module 208 comprises a computer vision module that operates in conjunction with one or more camera sensors. In another embodiment, the one or more camera sensors captures a scene around the target vehicle in form of at least one of one or more images and one or more videos. The computer vision module detects the one or more obstacles and the one or more collision zones around the target vehicle from the one or more images and the one or more videos. The computer vision module detects whether the one or more obstacles from the one or more images and the one or more videos lies within the one or more collision zones. The computer vision module communicates the first command to the collision warning module when the one or more obstacles from the one or more images and the one or more videos lies within the one or more collision zones. The first command instructs the collision warning module to activate the locking mechanism.

The computer vision module analyses at least one of the one or more images and one or more videos and detects whether the one or more obstacles is moving. In one embodiment, the computer vision module detects that the one or more obstacles is moving when the coordinates of the one or more obstacles in a first image is different when compared to a second image of the one or more images. In another embodiment, the computer vision module detects that the one or more obstacles is moving when the coordinates of the one or more obstacles in a first video is different when compared to a second video of the one or more videos. The computer vision module detects a speed of the one or more obstacles based on the coordinates of the one or more obstacles in the first video and the second video. The computer vision module calculates a time taken by the one or more obstacles to reach the one or more collision zones. The computer vision module communicates the first command to the auto lock unit 206 via the control module 202 to activate the locking mechanism for the predefined time until the obstacle is out of the collision zone.

In one embodiment, the control module 202 communicates a warning to the occupants through the infotainment unit 212 upon receiving command from the artificial intelligence module 208. The infotainment unit 212 displays the warning, alert, or message onto the display of the dashboard. The control module may also communicate the warning to the nearby vehicles, cyclist, etc., via an alarm, backlight, audio alert, etc. The nearby vehicles may maintain distance with the target vehicle, and the obstacle, to avoid collision. The vehicle may comprise the database 210 that stores the datasets as described herein.

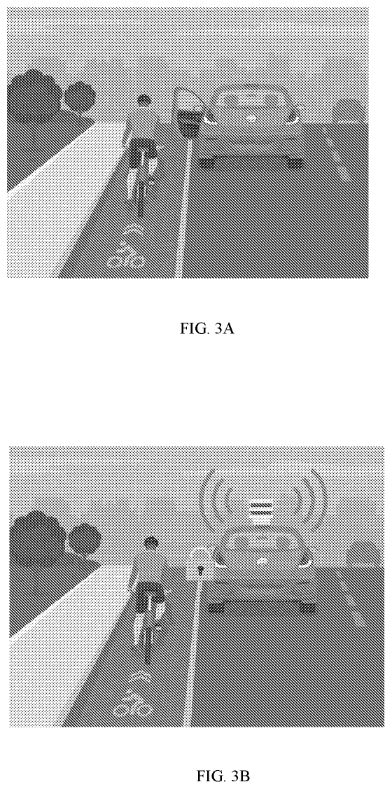

FIGS. 3A and 3B illustrate an obstacle approaching a target vehicle, according to one or more embodiments. The target vehicle is parked along the side of the road. The occupants within the vehicle may have opened the door for exiting and may have kept the door open being unaware of the fact that the obstacle (e.g., cyclist) is approaching the target vehicle. The collision warning module may be part of the target vehicle. In one embodiment, the collision warning module may be part of the one or more nearby vehicles. In another embodiment, the collision warning module may be part of an external infrastructure.

The one or more obstacles may approach alongside the target vehicle (as shown in FIG. 3A). The collision warning module may determine the one or more collision zones around the target vehicle. The collision warning module then determines the one or more obstacles around the target vehicle using the artificial intelligence module. The collision warning module then determines coordinates of the one or more obstacles around the target vehicle using the computer vision model in the artificial intelligence module. In one embodiment, the artificial intelligence module determines the distance and speed of the one or more obstacles to estimate a time period in which the lock is to be activated to avoid collision. The collision warning module then computes a probability of the one or more obstacles lying within the one or more collision zones as true when the coordinates of the one or more obstacles are within a range of the one or more collision zones. The collision warning module then communicates a first command to a control module of the target vehicle to activate a locking mechanism to one or more movable elements of the target vehicle via the auto lock unit.

In one embodiment, the control module activates a locking mechanism to one or more movable elements of the target vehicle via the auto lock unit for the estimated period. In one embodiment, the auto lock unit automatically closes the movable elements (as shown in FIG. 3B) and locks the movable elements. In one embodiment, the auto lock unit automatically closes the movable elements and locks the movable elements without manual intervention to avoid collision. In another embodiment, the auto lock unit automatically releases the lock and opens the movable elements without manual intervention after the estimated period. The control module may provide warning via lights, audio, etc., to the moving obstacles when the locks are released, and the movable elements are open.

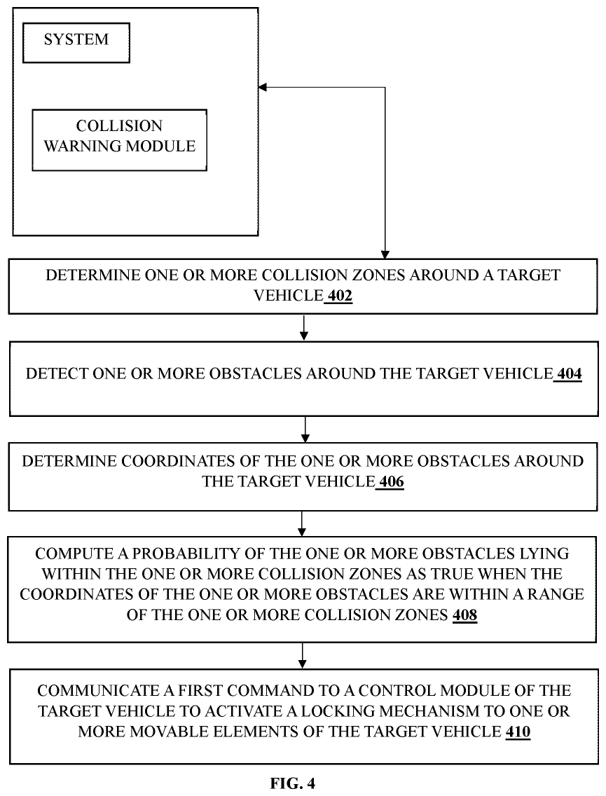

FIG. 4 illustrates a system, according to one or more embodiments. The system comprises a collision warning module. The system may be part of the target vehicle. In one embodiment, the system may be part of the nearby vehicle. In another embodiment, the system may be part of the external infrastructure. The collision warning module may comprise one or more sensors. The one or more sensors senses and detects the presence of the obstacles. In one embodiment, the sensors may also be adapted to determine the presence of the obstacles within the collision zones. The sensors communicate the data to the collision warning module.

The collision warning module is configured to execute the following technical steps. The collision warning module is configured to determine one or more collision zones around the target vehicle at step 402. The collision warning module is configured to detect one or more obstacles around the target vehicle at step 404. The collision warning module is then configured to determine coordinates of the one or more obstacles around the target vehicle at step 406. The collision warning module is then configured to compute a probability of the one or more obstacles lying within the one or more collision zones as true when the coordinates of the one or more obstacles are within a range of the one or more collision zones at step 408. The collision warning module is then configured to communicate a first command to a control module of the target vehicle to activate a locking mechanism to one or more movable elements of the target vehicle at step 410.

In one embodiment, the collision warning module is configured to communicate a first command to a control module of the target vehicle to activate a locking mechanism for a predefined period when the obstacle is moving. The collision warning module is configured to communicate a command to a control module of the target vehicle to deactivate a locking mechanism and release the lock when the obstacle has crossed the collision zone. The collision warning module is configured to communicate instructions to a control module of the target vehicle to maneuver a predefined location (safe area) away from the obstacles when the obstacles is static.

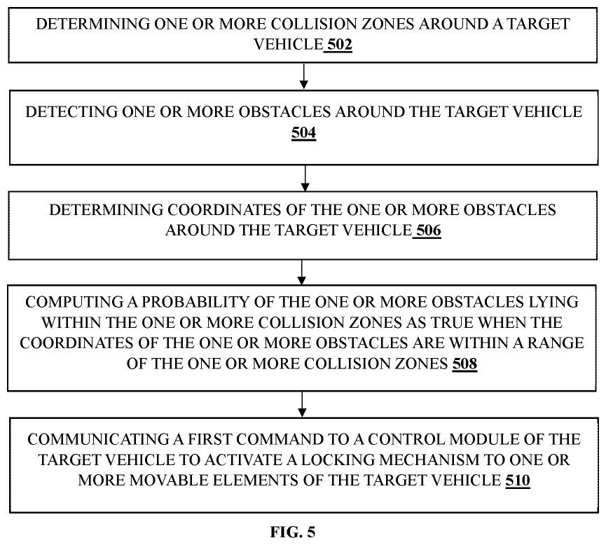

In another aspect, a method is described. FIG. 5 illustrates a method, according to one or more embodiments. The method comprises the technical steps that are executed by the collision warning module. At step 502, the collision warning module determines one or more collision zones around a target vehicle. At step 504, the collision warning module detects one or more obstacles around the target vehicle. At step 506, the collision warning module determines coordinates of the one or more obstacles around the target vehicle. At step 508, the collision warning module computes a probability of the one or more obstacles lying within the one or more collision zones as true when the coordinates of the one or more obstacles are within a range of the one or more collision zones. At step 510, the collision warning module communicates a first command to a control module of the target vehicle to activate a locking mechanism to one or more movable elements of the target vehicle. In one embodiment, the one or more collision zones are one of contiguous and non-contiguous and located in proximity to the one or more movable elements.

In one embodiment, the method further comprises the following technical steps executed by the collision warning module. The collision warning module computes the probability of the one or more obstacles lying within the one or more collision zones as false when the coordinates of the one or more obstacles are outside the range of the one or more collision zones. The collision warning module then communicates a second command to release the locking mechanism to the one or more movable elements when the probability of the one or more obstacles lying within the one or more collision zones is computed as false. The collision warning module determining the one or more collision zones around the target vehicle comprises the following technical steps. The collision warning module obtains a type and a model of the target vehicle. The collision warning module retrieves a specification of the target vehicle based on the type and the model of the target vehicle from a third party database. The collision warning module retrieves at least one of a position and operating information of the one or more movable elements of the target vehicle from one of the third party database and the specification of the target vehicle. The collision warning module determines the one or more collision zones based on one of the position and the operating information of the one or more movable elements of the target vehicle.

In an embodiment, the operating information comprises an operating mode, an operating type, an operating angle, a space occupied, and an operating level information. The operating mode comprises an automated operating mode and a manual operating mode. The operating angle comprises at least one of 45 degrees, 60 degrees, and 90 degrees. The operating level information comprises one of a level 1, a level 2, and a level 3. In an embodiment, the one or more obstacles comprises one or more objects, one or more animals, one or more nearby vehicles, one or more walls, one or more trees, one or more moving objects (e.g., moving animal, cyclist). The operating type comprises a regular type, a sliding type, a suicide type, a canopy type, a butterfly type, a raptor type, a swan type, a scissor type, a front hinged type, a dihedral synchro-helix actuation type, and a gull wing type. The sliding type operates along a length of the target vehicle. In an embodiment, the regular type operates outwards and opens away from a body of the target vehicle.

In an embodiment, the collision warning module is part of the target vehicle. In another embodiment, the collision warning module is part of one or more external infrastructures. In another embodiment, the collision warning module is part of one or more nearby vehicles. The one or more movable elements comprises one or more doors.

In an embodiment, the collision warning module determining the coordinates of the one or more obstacles around the target vehicle comprises the following technical steps. The collision warning module captures one or more images around the target vehicle encompassing the one or more obstacles and the one or more collision zones. The collision warning module overlays a ruler onto the one or more images and marking points of the one or more obstacles. The collision warning module determines the coordinates of the one or more obstacles.

In another embodiment, the method further comprises the technical steps executed by the collision warning module. The collision warning module marks one or more boundaries of the one or more collision zones and determines coordinates of the one or more boundaries of the one or more collision zones. The collision warning module determines the coordinates of the one or more obstacles around the target vehicle comprises the technical steps executed by the collision warning module. The collision warning module captures one or more images around the target vehicle encompassing the one or more obstacles and the one or more collision zones. The collision warning module overlays a ruler onto the one or more images and marks points of the one or more obstacles. The collision warning module determines the coordinates of the one or more obstacles. The collision warning module further marks the one or more boundaries of the one or more collision zones and determines the coordinates of the one or more boundaries of the one or more collision zones.

In another embodiment, the method further comprises the following technical steps executed by the computer vision module. The computer vision module captures a scene around the target vehicle using one or more camera sensors in form of at least one of one or more images and one or more videos. The computer vision module detects the one or more obstacles and the one or more collision zones around the target vehicle from the one or more images and the one or more videos. The computer vision module detects whether the one or more obstacles from the one or more images and the one or more videos lies within the one or more collision zones. The computer vision module communicates the first command to the collision warning module when the one or more obstacles from the one or more images and the one or more videos lies within the one or more collision zones. The first command instructs the collision warning module to activate the locking mechanism via the control module.

The computer vision module analyzes at least one of the one or more images and one or more videos and detects whether one or more obstacles is moving. The computer vision module detects the one or more obstacles is moving when the coordinates of the one or more obstacles in a first image is different when compared to a second image of the one or more images. In one embodiment, the computer vision module detects the one or more obstacles is moving when the coordinates of the one or more obstacles in a first video is different when compared to a second video of the one or more videos.

The computer vision module determines a speed and a distance of the one or more obstacles based on the coordinates of the one or more obstacles in the first video and the second video. The computer vision module calculates a time taken by the one or more obstacles to reach the one or more collision zones based on the speed and the distance. The computer vision module then communicates the first command to the collision warning module within a predefined time from the time calculated to activate the locking mechanism.

In another embodiment, the computer vision module analyzes the coordinates of the one or more boundaries of the one or more collision zones and determines whether the coordinates of the one or more obstacles are within the one or more boundaries of the one or more collision zones. In another embodiment, the computer vision module computes the probability of the one or more obstacles lying within the one or more collision zones as true when the coordinates of the one or more obstacles are within the coordinates of the one or more boundaries of the one or more collision zones. In another embodiment, the collision warning module computes the probability of the one or more obstacles lying within the one or more collision zones as false when the coordinates of the one or more obstacles is outside the coordinates of the one or more boundaries of the one or more collision zones.

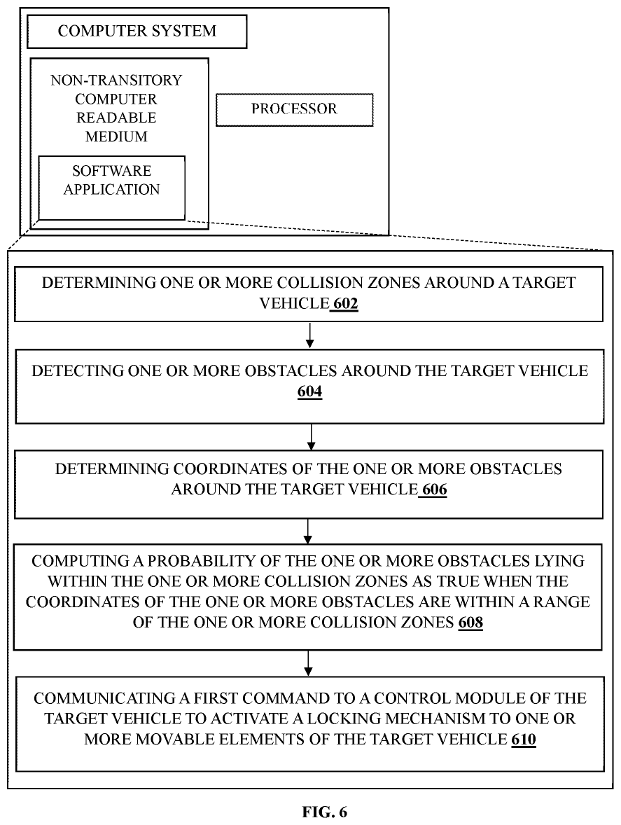

In yet another aspect, a non-transitory storage medium is described. FIG. 6 illustrates the non-transitory storage medium, according to one or more embodiments. The non-transitory storage medium stores a sequence of instructions which when executed by a processor causes: determining one or more collision zones around a target vehicle, at step 602; detecting one or more obstacles around the target vehicle, at step 604; determining coordinates of the one or more obstacles around the target vehicle, at step 606; computing a probability of the one or more obstacles lying within the one or more collision zones as true when the coordinates of the one or more obstacles are within a range of the one or more collision zones, at step 608; communication of a first command to a control module of the target vehicle to activate a locking mechanism to one or more movable elements of the target vehicle, at step 610.

In one embodiment, the non-transitory storage medium further causes: computing the probability of the one or more obstacles lying within the one or more collision zones as false when the coordinates of the one or more obstacles are outside the range of the one or more collision zones. The non-transitory storage medium further causes: communicating a second command to release the locking mechanism to the one or more movable elements when the probability of the one or more obstacles lying within the one or more collision zones is computed as false.

In another embodiment, the non-transitory storage medium determining the one or more collision zones around the target vehicle: obtains a type and a model of the target vehicle; retrieves a specification of the target vehicle based on the type and the model of the target vehicle from a third party database; retrieves at least one of a position and operating information of the one or more movable elements of the target vehicle from one of the third party database and the specification of the target vehicle; and determines the one or more collision zones based on one of the position and the operating information of the one or more movable elements of the target vehicle.

In one embodiment, the non-transitory storage medium further causes: capturing a scene around the target vehicle, by a computer vision module, using one or more camera sensors in form of at least one of one or more images and one or more videos. The non-transitory storage medium further causes: detecting the one or more obstacles and the one or more collision zones around the target vehicle from the one or more images and the one or more videos. In one embodiment, the non-transitory storage medium further causes: detecting whether the one or more obstacles from the one or more images and the one or more videos lie within the one or more collision zones. The non-transitory storage medium further causes: communicating the first command to a collision warning module when the one or more obstacles from the one or more images and the one or more videos lie within the one or more collision zones. The first command instructs the collision warning module to activate the locking mechanism.

In another embodiment, the non-transitory storage medium further causes: analyzing at least one of one or more images and the one or more videos and detecting whether the one or more obstacles is moving. The non-transitory storage medium further causes: detecting the one or more obstacles is moving when the coordinates of the one or more obstacles in a first image is different when compared to a second image of the one or more images. In one embodiment, the non-transitory storage medium further causes: detecting the one or more obstacles is moving when the coordinates of the one or more obstacles in a first video is different when compared to a second video of the one or more videos. The non-transitory storage medium further causes: determining a speed and a distance of the one or more obstacles based on the coordinates of the one or more obstacles in the first video and the second video. The non-transitory storage medium further causes: calculating a time taken by the one or more obstacles to reach the one or more collision zones based on the speed and the distance. In one embodiment, the non-transitory storage medium further causes: communicating the first command to a collision warning module within a predefined time from the time calculated to activate the locking mechanism.

In an embodiment, the non-transitory storage medium determining the coordinates of the one or more obstacles around the target vehicle causes: capturing one or more images around the target vehicle encompassing the one or more obstacles and the one or more collision zones; overlaying a ruler onto the one or more images and marking points of the one or more obstacles; and determining the coordinates of the one or more obstacles. In another embodiment, the non-transitory storage medium further causes: marking one or more boundaries of the one or more collision zones and determining coordinates of the one or more boundaries of the one or more collision zones. The non-transitory storage medium further causes: analyzing the coordinates of the one or more boundaries of the one or more collision zones and determining whether the coordinates of the one or more obstacles are within the one or more boundaries of the one or more collision zones. In one embodiment, the non-transitory storage medium further causes: computing the probability of the one or more obstacles lying within the one or more collision zones as true when the coordinates of the one or more obstacles are within the coordinates of the one or more boundaries of the one or more collision zones. In another embodiment, the non-transitory storage medium further causes: computing the probability of the one or more obstacles lying within the one or more collision zones as false when the coordinates of the one or more obstacles is outside the coordinates of the one or more boundaries of the one or more collision zones.

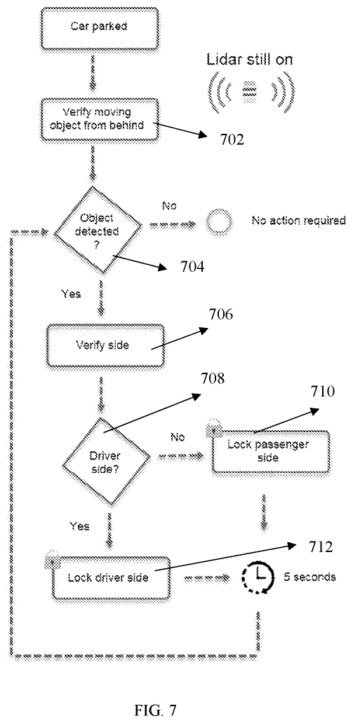

FIG. 7 illustrates a flowchart illustrating determination of obstacles around the target vehicle and prevention of collision, according to one or more embodiments. The target vehicle may be parked, and the occupants may be relaxing and about to step out. The occupants need to open the vehicle door to step out. At step 702, the collision warning module detects the one or more obstacles around the target vehicle is moving. The collision warning module is configured to determine one or more collision zones around the target vehicle. Each collision zone is associated with each movable element. The one or more collision zones are contiguous. In one embodiment, the one or more collision zones are non-contiguous. At step 704, the collision warning module detects and confirms whether the one or more obstacles around the target vehicle is within the one or more collision zones. If no object is detected, the collision warning module remains idle and takes no action. The collision warning module continues to monitor for one or more obstacles around the target vehicle.

At step 706, the collision warning determines on which side (e.g., driver side, passenger side, etc.) the obstacles are approaching the vehicle. At step 708, the collision warning determines whether the obstacle approaches the driver's side. The collision warning module activates the locks for the movable elements on the passenger side at step 710 when the collision warning module determines that the obstacle approaches the other side (e.g., passenger side). The collision warning module activates the locks for the movable elements on the driver side, at step 712, when the collision warning determines that the obstacle approaches the driver side. In one embodiment, the collision warning module activates the locks for the movable elements for a predefined time. The predefined time corresponds to the time taken for the obstacle to cross the collision zones of the vehicles.

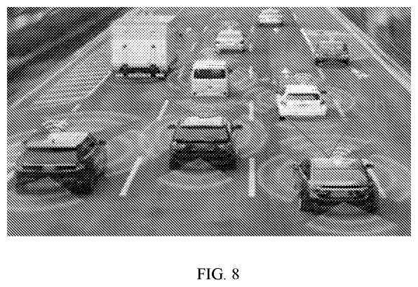

FIG. 8 illustrates a vehicle to vehicle data transfer, according to one or more embodiments. In one embodiment, the system is part of the nearby vehicle, target vehicle and/or external infrastructure configured to detect the obstacle and compute the probability of collision. The system comprises sensors to determine the obstacle. In one embodiment, the sensors may reside outside the system in one or more external infrastructures. The system, upon computing the obstacle, determines the probability of the collision between the obstacle and the vehicle. The system determines the probability of collision on all sides of the target vehicle. The system within the nearby vehicle then communicates the instructions to the surrounding or nearby vehicles via a vehicle to vehicle (V2V) data transfer.

The nearby vehicles travelling in the same direction towards the restriction obstacles are informed about the probability of the collision. The control module and/or electric drive unit within the respective vehicle then performs the maneuvering automatically to avoid collision. In case of the manual driven vehicle, the control module and/or electric drive unit within the respective vehicle may provide instructions via a display on the dashboard of the vehicle. The control module within the respective vehicles then communicates appropriate instructions to the electric drive unit to take appropriate actions (such as maneuvering towards the middle lane, or the shoulder of the road) to avoid collision).

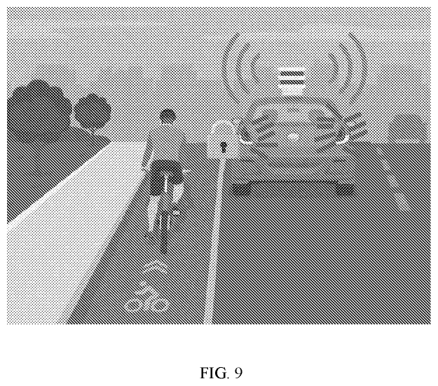

FIG. 9 illustrates a warning provided by the target vehicle upon predicting the collision of an obstacle with the target vehicle, according to one or more embodiments. The collision warning module may determine the one or more collision zones around the target vehicle. The collision warning module then determines the one or more obstacles around the target vehicle. The collision warning module then determines coordinates of the one or more obstacles around the target vehicle. The collision warning module then computes a probability of the one or more obstacles lying within the one or more collision zones as true when the coordinates of the one or more obstacles are within a range of the one or more collision zones. The collision warning module then communicates a first command to a control module of the target vehicle to activate a locking mechanism to one or more movable elements of the target vehicle via the auto lock unit.

In one embodiment, the control module activates the locking mechanism to one or more movable elements of the target vehicle via the auto lock unit for the predefined period. In one embodiment, the auto lock unit automatically closes the movable elements without manual intervention. The collision warning module further provides warning to the one or more obstacles. The collision warning module provides the warning by blinking the lights (e.g., backlights, indicator lights, front lights, hazard lamps, etc.). The collision warning module may also provide the warning by honks, beeps, audio alerts, videos, text displays, etc. (as show in FIG. 9).

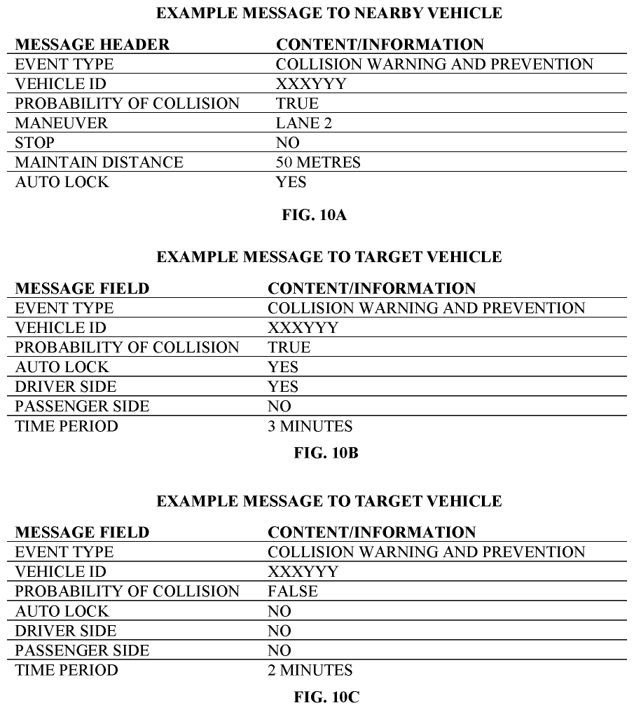

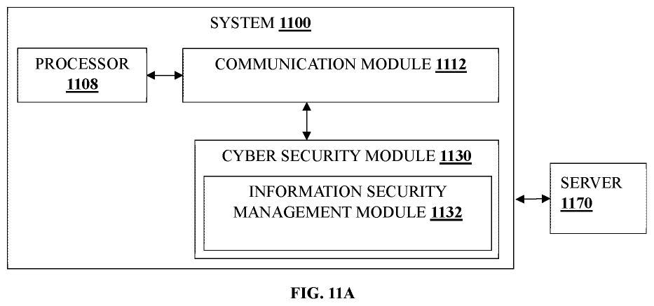

FIGS. 10A, 10B, and 10C illustrate sample messages communicated by the collision warning module, according to one or more embodiments. The nearby vehicle receives the sample message from the collision warning module as shown in FIG. 10A. The sample message shown in FIG. 10A comprises fields such as event type, vehicle ID, probability of collision, maneuver, stop, maintain distance, and auto lock.

The “event type” field may be collision warning and prevention. The “vehicle ID” field may comprise a serial identification number, or a tag associated with the electric vehicle configured to identify and locate the electric vehicle. The “probability of collision” field based on the current scenario, in or of the nearby vehicle, is one of true and false. This message is shown or communicated in or to the nearby vehicle. The field “maneuver” indicates maneuvering direction and route appropriately. The field “stop” indicates YES or NO appropriately. The field “maintain distance” indicates the approximate distance to be maintained by the nearby vehicle from the target vehicle. The field “auto lock” indicates YES or NO. YES indicates activating locking mechanism to the movable elements of the nearby vehicle. NO indicates deactivating locking mechanism to the movable elements of the nearby vehicle.

The target vehicle receives the sample message from the collision warning module as shown in FIGS. 10B and 10C. The sample message shown in FIG. 10B-10C comprises fields such as event type, vehicle ID, probability of collision, auto lock, driver side, passenger side and time period. The “event type” field may be collision warning and prevention. The “vehicle ID” field may comprise a serial identification number, or a tag associated with the electric vehicle configured to identify and locate the electric vehicle. The “probability of collision” field based on the current scenario indicates one of true and false. The field “auto lock” indicate YES or NO appropriately based on the probability of collision. The field “driver side” indicates YES or NO. If YES, the lock is to be activated on the driver's side. If NO, no action is to be taken on the driver's side. The field “passenger side” indicates YES or NO. If YES, the lock is to be activated on the passenger side. If NO, no action is to be taken on the passenger side. The filed “time period” indicates the time period for which the lock is to be activated.

In an embodiment, the system further comprises a cyber security module wherein the cyber security module comprises an information security management module providing isolation between the communication module and servers.

In an embodiment, the information security management module is operable to, receive data from the communication module, exchange a security key at a start of the communication between the communication module and the server, receive the security key from the server, authenticate an identity of the server by verifying the security key, analyze the security key for a potential cyber security threat, negotiate an encryption key between the communication module and the server, encrypt the data, and transmit the encrypted data to the server when no cyber security threat is detected.

In an embodiment, the information security management module is operable to exchange a security key at a start of the communication between the communication module and the server, receive the security key from the server, authenticate an identity of the server by verifying the security key, analyze the security key for a potential cyber security threat, negotiate an encryption key between the system and the server, receive encrypted data from the server, decrypt the encrypted data, perform an integrity check of the decrypted data and transmit the decrypted data to the communication module when no cyber security threat is detected.

In an embodiment, the system may comprise a cyber security module. In one aspect, a secure communication management (SCM) computer device for providing secure data connections is provided. The SCM computer device includes a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message into a first data format associated with the vehicle environment and transmit the converted first data message to the communication module using a first communication protocol associated with the negotiated protocol.

According to an embodiment, secure authentication for data transmissions comprises, provisioning a hardware-based security engine (HSE) located in the cyber security module, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the cyber security module with other computing system subjects (e.g., communication module) to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

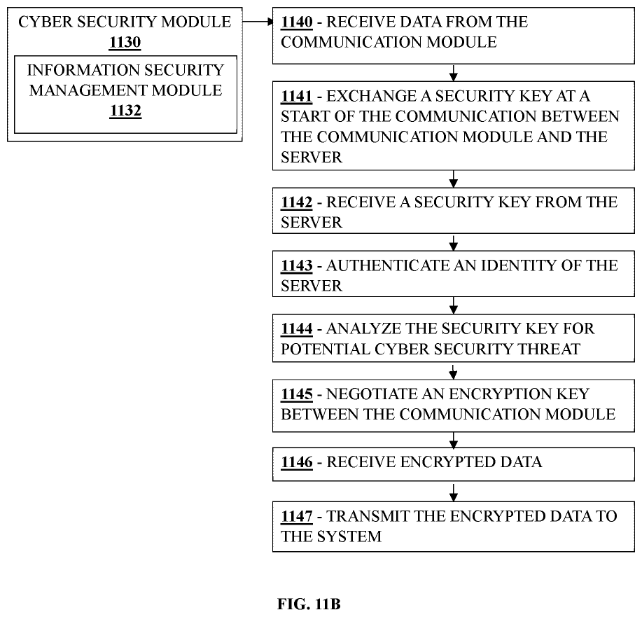

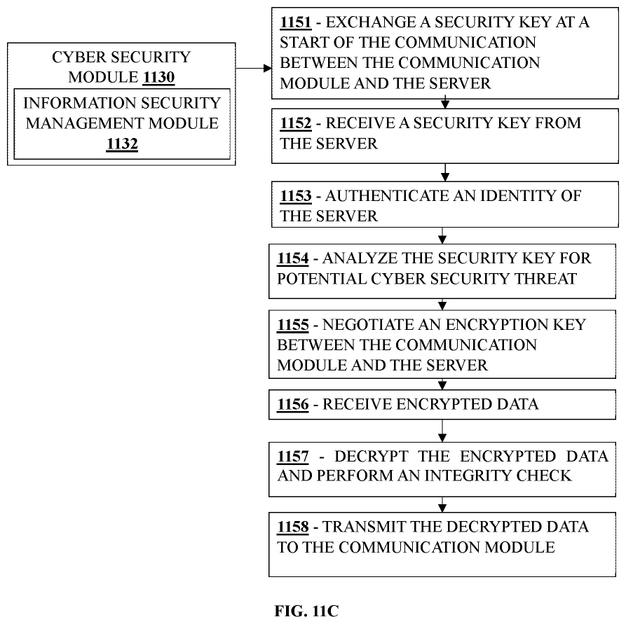

FIG. 11A shows the block diagram of the cyber security module according to an embodiment. In an embodiment, FIG. 11A shows the block diagram of the cyber security module. The communication of data between the system 1100 and the server 1170 through the communication module 1112 is first verified by the information security management module 1132 of the cyber security module 1130 before being transmitted from the system to the server or from the server to the system. The information security management module is operable to analyze the data for potential cyber security threats, to encrypt the data when no cyber security threat is detected, and to transmit the data encrypted to the system or the server. System 1100 comprises a processor 1108.

In an embodiment, the cyber security module further comprises an information security management module providing isolation between the system and the server. FIG. 11B shows the flowchart of securing the data through the cyber security module 1130. At step 1140, the information security management module 1132 is operable to receive data from the communication module. At step 1141, the information security management module exchanges a security key at the start of the communication between the communication module and the server. At step 1142, the information security management module receives a security key from the server. At step 1143, the information security management module authenticates an identity of the server by verifying the security key. At step 1144, the information security management module analyzes the security key for potential cyber security threats. At step 1145, the information security management module negotiates an encryption key between the communication module and the server. At step 1146, the information security management module receives the encrypted data. At step 1147, the information security management module transmits the encrypted data to the server when no cyber security threat is detected.

In an embodiment, FIG. 11C shows the flowchart of securing the data through the cyber security module 1130. At step 1151, the information security management module 1132 is operable to: exchange a security key at the start of the communication between the communication module and the server. At step 1152, the information security management module receives a security key from the server. At step 1153, the information security management module authenticates an identity of the server by verifying the security key. At step 1154, the information security management module analyzes the security key for potential cyber security threats. At step 1155, the information security management module negotiates an encryption key between the communication module and the server. At step 1156, the information security management module receives encrypted data. At step 1157, the information security management module decrypts the encrypted data, and performs an integrity check of the decrypted data. At step 1158, the information security management module transmits the decrypted data to the communication module when no cyber security threat is detected.

In an embodiment, the integrity check is a hash-signature verification using a Secure Hash Algorithm 256 (SHA256) or a similar method. In an embodiment, the information security management module is configured to perform asynchronous authentication and validation of the communication between the communication module and the server.

In an embodiment, the information security management module is configured to raise an alarm if a cyber security threat is detected. In an embodiment, the information security management module is configured to discard the encrypted data received if the integrity check of the encrypted data fails.

In an embodiment, the information security management module is configured to check the integrity of the decrypted data by checking accuracy, consistency, and any possible data loss during the communication through the communication module.

In an embodiment, the server is physically isolated from the system through the information security management module as shown in FIG. 11A. When the system communicates with the server as shown in FIG. 11B, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module and cyber security module. When the information security management module receives data through the communication module as shown in FIG. 11C, the data is decrypted first, integrity verification is carried out on the data after decryption, and if verification is passed, the data is sent out through the communication module; otherwise, the data is discarded. In an embodiment, the identity authentication is realized by adopting an asymmetric key with a signature.

In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine.

In an embodiment, both communication parties need to authenticate their own identities through a pair of asymmetric keys, and a task in charge of communication with the information security management module of the system is identified by a unique pair of asymmetric keys.

In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and may ensure that the safety of the data on the server cannot be compromised by a hacker attack under the condition of the Internet by ensuring the safety and reliability of the communication between the system and the server.

In an embodiment of the system, the machine learning model is configured to learn using labelled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment of the system, the machine learning model is configured to learn from the real-time data using an unsupervised learning method, wherein the unsupervised learning method comprises logic using at least one of a k-means clustering, a hierarchical clustering, a hidden Markov model, and an apriori algorithm.

In an embodiment of the system, the machine learning model has a feedback loop, wherein the output from a previous step is fed back to the model in real-time to improve the performance and accuracy of the output of a next step.

In an embodiment of the system, the machine learning model comprises a recurrent neural network model.

In an embodiment of the system, the machine learning model has a feedback loop, wherein the learning is further reinforced with a reward for each true positive of the output of the system.

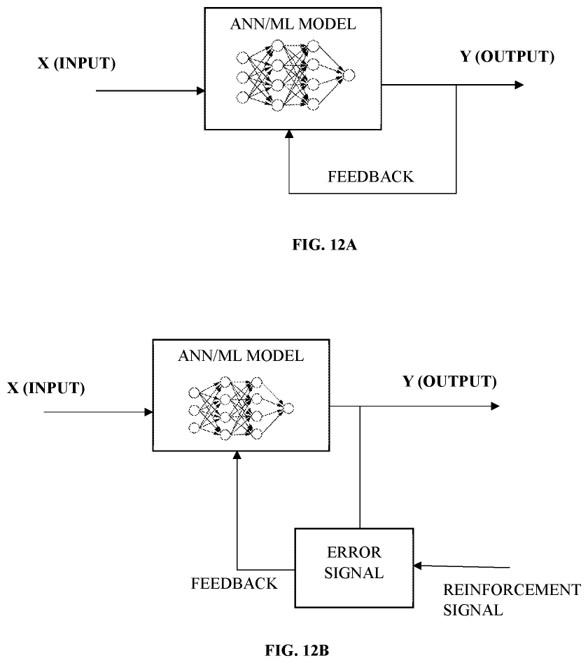

FIG. 12A shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may predict or detect the presence of obstacle, probability of collision, time period for which the lock is to be activated.

In an embodiment, ANN's may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the AI/ML model is trained well, with large sets of labelled data and concepts, after a while, the models' performance may decline while adding new, unlabelled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabelled data is assimilated. A feedback loop refers to the process by which an AI model's predicted output is reused to train new versions of the model.

Initially, when the AI/ML model is trained, a few labelled samples comprising both positive and negative examples of the concepts (e.g., probability of collision) are used that are meant for the model to learn. Afterward, the model is tested using unlabelled data. By using, for example, deep learning and neural networks, the model can then make predictions on whether the desired concept/s (e.g., probability of collision) are in unlabelled images. Each image is given a probability score where higher scores represent a higher level of confidence in the models' predictions. Where a model gives an image a high probability score, it is auto labelled with the predicted concept. However, in the cases where the model returns a low probability score, this input may be sent to a controller (may be a human moderator) which verifies and, as necessary, corrects the result. The human moderator may be used only in exceptional cases. The feedback loop feeds labelled data, auto-labelled or controller-verified data back to the model dynamically and is used as training data so that the system can improve its predictions in real-time and dynamically.

FIG. 12B shows a structure of the neural network/machine learning model with reinforcement learning. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes”, “has”, “possesses”, and the like are used in the detailed description, claims, appendices and/or drawings such terms are intended to be inclusive in a manner similar to the term “comprising” as “comprising” is interpreted when employed as a transitional word in a claim.

Other specific forms may embody the present invention without departing from its spirit or characteristics. The described embodiments are in all respects illustrative and not restrictive. Therefore, the appended claims rather than the description herein indicate the scope of the invention. All variations which come within the meaning and range of equivalency of the claims are within their scope.

1-94. (canceled)

95. A system comprising:
a collision warning module configured to:
determine one or more collision zones around a target vehicle;
detect one or more obstacles around the target vehicle;
determine coordinates of the one or more obstacles around the target vehicle;
compute a probability of the one or more obstacles lying within the one or more collision zones as true when the coordinates of the one or more obstacles are within a range of the one or more collision zones; and
communicate a first command to a control module of the target vehicle to activate a locking mechanism to one or more movable elements of the target vehicle.

96. The system of claim 95, wherein the collision warning module is configured to compute the probability of the one or more obstacles lying within the one or more collision zones as false when the coordinates of the one or more obstacles are outside the range of the one or more collision zones.

97. The system of claim 96, wherein the collision warning module is configured to communicate a second command to release the locking mechanism to the one or more movable elements when the probability of the one or more obstacles lying within the one or more collision zones is computed as false.

98. The system of claim 95, wherein the collision warning module determining the one or more collision zones around the target vehicle comprises:
obtain a type and a model of the target vehicle;
retrieve a specification of the target vehicle based on the type and the model of the target vehicle from a third party database;
retrieve at least one of a position and operating information of the one or more movable elements of the target vehicle from one of the third party database and the specification of the target vehicle; and
determine the one or more collision zones based on one of the position and the operating information of the one or more movable elements of the target vehicle.

99. The system of claim 95, wherein the one or more movable elements comprises one or more doors.

100. The system of claim 95, wherein the collision warning module comprises one or more sensors that comprising one or more Light Detection and Ranging (LIDAR) sensors, one or more ultrasonic sensors, one or more camera sensors, one or more infrared sensors, one or more radio detection and ranging (RADAR) sensors and one or more advanced driver assistance system (ADAS) sensors.

101. The system of claim 95, wherein the system comprises an artificial intelligence module.

102. The system of claim 101, wherein the artificial intelligence module comprises a computer vision module that operates in conjunction with one or more camera sensors that captures a scene around the target vehicle in form of at least one of one or more images and one or more videos.

103. The system of claim 102, wherein the computer vision module detects the one or more obstacles and the one or more collision zones around the target vehicle from the one or more images and the one or more videos and detects whether the one or more obstacles from the one or more images and the one or more videos lies within the one or more collision zones.

104. The system of claim 103, wherein the computer vision module communicates the first command to the collision warning module to activate the locking mechanism when the one or more obstacles from the one or more images and the one or more videos lies within the one or more collision zones.

105. The system of claim 102, wherein the computer vision module analyses the at least one of the one or more images and the one or more videos and detects whether the one or more obstacles is moving when the coordinates of the one or more obstacles in a first image is different when compared to a second image of the one or more images.

106. The system of claim 105, wherein the computer vision module detects a speed of the one or more obstacles based on the coordinates of the one or more obstacles in a first video and a second video of the one or more videos and calculates a time taken by the one or more obstacles to reach the one or more collision zones.

107. A method comprising:
determining, by a collision warning module, one or more collision zones around a target vehicle;
detecting, by the collision warning module, one or more obstacles around the target vehicle;
determining, by the collision warning module, coordinates of the one or more obstacles around the target vehicle;
computing, by the collision warning module, a probability of the one or more obstacles lying within the one or more collision zones as true when the coordinates of the one or more obstacles are within a range of the one or more collision zones; and
communicating, by the collision warning module, a first command to a control module of the target vehicle to activate a locking mechanism to one or more movable elements of the target vehicle.

108. The method of claim 107, wherein determining, by the collision warning module, the coordinates of the one or more obstacles around the target vehicle comprises:
capturing one or more images around the target vehicle encompassing the one or more obstacles and the one or more collision zones
overlaying a ruler onto the one or more images and marking points of the one or more obstacles; and
determining the coordinates of the one or more obstacles.

109. The method of claim 108, further comprising: marking, by the collision warning module, one or more boundaries of the one or more collision zones and determining coordinates of the one or more boundaries of the one or more collision zones.

110. The method of claim 109, further comprising: analyzing, by a computer vision module, the coordinates of the one or more boundaries of the one or more collision zones and determining whether the coordinates of the one or more obstacles are within the one or more boundaries of the one or more collision zones.

111. The method of claim 110, further comprising: computing, by the collision warning module, the probability of the one or more obstacles lying within the one or more collision zones as true when the coordinates of the one or more obstacles are within the coordinates of the one or more boundaries of the one or more collision zones.

112. The method of claim 110, further comprising: computing, by the collision warning module, the probability of the one or more obstacles lying within the one or more collision zones as false when the coordinates of the one or more obstacles is outside the coordinates of the one or more boundaries of the one or more collision zones.

113. A non-transitory storage medium storing a sequence of instructions which when executed by a processor causes:
determining one or more collision zones around a target vehicle;
detecting one or more obstacles around the target vehicle;
determining coordinates of the one or more obstacles around the target vehicle;
computing a probability of the one or more obstacles lying within the one or more collision zones as true when the coordinates of the one or more obstacles are within a range of the one or more collision zones; and
communicate a first command to a control module of the target vehicle to activate a locking mechanism to one or more movable elements of the target vehicle.

114. The non-transitory storage medium of claim 113, wherein determining the one or more collision zones around the target vehicle causes:
obtain a type and a model of the target vehicle;
retrieve a specification of the target vehicle based on the type and the model of the target vehicle from a third party database;
retrieve at least one of a position and operating information of the one or more movable elements of the target vehicle from one of the third party database and the specification of the target vehicle; and
determine the one or more collision zones based on one of the position and the operating information of the one or more movable elements of the target vehicle.
